(19) United States
(12) Patent Application Publication
(10) Pub. No.: US 2013/0046589 A1
(43) Pub. Date: Feb. 21, 2013

(54) VARYING OFFERS BASED ON PROXIMITY TO CUSTOMER'S CURRENT LOCATION

(71) Applicants: David M. Grigg, Rock Hill, SC (US); Matthew A. Calman, Charlotte, NC (US); Raja Bose, Charlotte, NC (US); Erik Stephen Ross, Charlotte, NC (US)

(72) Inventors: David M. Grigg, Rock Hill, SC (US); Matthew A. Calman, Charlotte, NC (US); Raja Bose, Charlotte, NC (US); Erik Stephen Ross, Charlotte, NC (US)

(73) Assignee: Bank of America Corporation, Charlotte, NC (US)

(21) Appl. No.: 13/213,792

(22) Filed: Aug. 19, 2011

(51) Int. Cl. G06Q 30/00

(52) U.S. Cl. 705/14.1; 705/14.53

(57) ABSTRACT

Embodiments of the invention are directed to methods, systems, apparatus and computer program products are described herein for communicating offers to customers based in part on the distance from the customer to the merchant's location after receiving an indication of a point of transaction event by receiving an indication of a point-of-transaction event, collecting positioning information related to the customer, determining the distance between the customer and the merchant, correlating the distance between the customer and the merchant to offers to entice the customer to travel to the merchant's location and communicating the offers to the customer.

### FIELD

In general, embodiments of the invention relate to methods, systems, apparatus and computer program products for communicating offers to customers based in part on the distance from the customer to the merchant's location after receiving an indication of a point of transaction event.

### BACKGROUND

Oftentimes, when a merchant communicates offers to potential customers for products or services, the offer is the same for all customers without consideration as to whether the customer is close to the merchant's location or would have to travel some distance to take advantage of the merchant's offer. However, this fails to take into account that the customer who must travel a greater distance to take advantage of the merchant's offer will generally require a greater incentive to choose to accept the offer than a customer who does not need to travel as far.

If a merchant does consider the relative distance of its customers when communicating offers, it is currently based on a fixed location of the customer, such as the customer's place of residence or business. This may not provide an accurate picture of where the customer is when he or she is engaged in commercial activity.

Therefore, a need exists for a system that can identify the current location of a customer in order to target offers to the customer that vary depending on the distance of the customer to the merchant's location.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Some embodiments of the present invention provide a method for communicating offers for goods and services that involves receiving an indication of a point of transaction event involving a customer, collecting data about the customer's location, determining the distance between the customer and a merchant, correlating the distance between the customer and merchant to offers, wherein the offers are intended to entice the customer to travel to the merchant's location and communicating the offers to the customer. Certain embodiments will feature the additional steps of collecting a second set of data, wherein the second set of data comprises information about the customer and choosing one or more offers to communicate to the customer based in part on the second set of data.

In some embodiments, the customer's location data is collected from at least one of a global positioning data, mobile device data, social network data, or Internet search data. In some embodiments the second set of data is collected from at least one of transactional data, biographical data, social network data or publicly available data. In some embodiments the indication of a point of transaction event will include information regarding the transaction. In certain embodiments such information will comprise the time the transaction occurred. In some embodiments, the information regarding the transaction comprises the location where the transaction occurred. In some embodiments the information regarding the transaction comprises item level information about the goods or services purchased during the transaction. Consistent with some embodiments of the invention, the customer's location may be determined in part based on the indication of a point of transaction event. Further, in some embodiments choosing one or more offers to communicate to the customer is based in part on the indication of a point of transaction event. In certain embodiments the offers are selected from discounts for goods or services offered by the merchant, discounts for goods or services offered by other merchants, access to goods or services otherwise unavailable to the customer, reductions in fees

According to certain embodiments the method for communicating offers for goods and services further comprises the steps of receiving information from the customer relative to the customer's location or the offers communicated to the customer and adjusting the determined distance between the customer and the merchant and/or identifying alternate offers to entice the customer to travel to the merchant's location, based in part on the information received from the customer and communicating alternative offers to the customer.

Embodiments of the invention also provide an apparatus featuring a computing platform with a memory and at least one processor operatively connected with the memory, wherein the processor is configured to receive an indication of a point of transaction event involving a customer, collect a first set of data, wherein the first set of data comprises information related to the customer's physical location, determine a distance between the customer and a merchant, based in part on the first set of data, correlate the distance between the customer and the merchant to offers intended to entice the customer to travel to the merchant's location and communicate the offers to the customer. In certain embodiments, the processor is also configured to collect a second set of data, wherein the second set of data comprises information about the customer, and to choose one or more offers to communicate to the customer based in part on the second set of data.

In some embodiments of the apparatus the first set of data is collected from at least one of global positioning data, mobile device data, social network data or search data. In some embodiments the second set of data is collected from at least one of transactional data, biographical data, social network data or publicly available data. In certain embodiments of the apparatus the indication of a point of transaction event will include information regarding the transaction. In some such embodiments the information will comprise the time the transaction occurred. In some embodiments, the information regarding the transaction comprises the location where the transaction occurred. In some embodiments the information regarding the transaction comprises item level information about the goods or services purchased during the transaction. Consistent with some embodiments of the apparatus, the first set of customer data may include the indication of a point of transaction event. In certain embodiments, the processor is configured to choose one or more offers to communicate to the customer based in part on the indication of a point of transaction event.

The processor of the apparatus, in some embodiments is further configured to receive information from the customer relative to the customer's location, adjust the determined distance between the customer and the merchant, based in part on the information received from the customer, and communicate alternative offers to the customer. In other embodiments, the processor of the apparatus is further configured to receive information from the customer relative to the communicated offers, identify alternate offers to entice the customer to travel to the merchant's location, based in part on the information received from the customer and communicate alternative offers to the customer.

Embodiments of the invention also provide a computer program product comprising a non-transitory computer-readable medium having computer-executable code stored thereon. In one embodiment, the computer-executable code includes: a first code portion configured to receive an indication of a point of transaction event, a second code portion configured to collect a first set of data, wherein the first set of data comprises the customer's location, a third code portion configured to determine a distance between the customer and the merchant, based in part on the first set of data, a fourth code portion configured to correlate the distance between the customer and the merchant to offers, wherein the offers are intended to entice the customer to travel to the merchant's location, and a fifth code portion configured to communicate the offers to the customer. In certain embodiments, the computer-executable code also includes a code portion configured to collect a second set of data, wherein said second set of data comprises information about the customer and a code portion configured to choose one or more offers to communicate to the customer based in part on the second set of data. In some embodiments, the computer-executable code also includes a code portion configured to receive information from the customer relative to the customer's location, adjust the determined distance between the customer's location and the merchant based in part on the information received from the customer and communicate alternative offers to the customer. In other embodiments, the computer-executable code also includes a code portion configured to receive information from the customer relative to the communicated offers, identify alternate offers to entice the customer to travel to the merchant's location, based in part on the information received from the customer, and communicate alternative offers to the customer.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a flow diagram illustrating a process flow for communicating offers for goods and services based on the customer's current location, in accordance with an embodiment of the present invention;

FIG. 2 provides a flow diagram illustrating a process flow for collecting positioning data of the customer, in accordance with an embodiment of the present invention;

FIG. 3a provides a mixed block and flow diagram illustrating a process flow for communicating offers for goods and services based on the customer's current location, in accordance with an embodiment of the present invention;

FIG. 3b provides a mixed block and flow diagram illustrating a process flow for communicating offers for goods and services based on the customer's current location, in accordance with an embodiment of the present invention;

FIG. 4 provides a flow diagram illustrating a process flow for collecting customer data, in accordance with an embodiment of the present invention; and

FIG. 5 provides a block diagram illustrating technical components of a system for communicating offers for goods and services based on the customer's current location, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Although embodiments of the present invention described herein are generally described as involving a merchant, it will be understood that the merchant may involve one or more persons, organizations, businesses, institutions and/or other entities such as financial institutions, services providers etc. that implement one or more portions of one or more of the embodiments described and/or contemplated herein.

The embodiments described herein may refer to use of a transaction, transaction event to trigger the steps, functions, routines etc. described herein. In various embodiments, occurrence of a transaction also triggers the sending of information such as offers and the like. Unless specifically limited by the context, a “transaction”, “transaction event” or “point of transaction event” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction”could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo Wii®, PlayStation Portable®, etc.), and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

Thus, methods, systems, apparatus and computer program products are described herein for communicating offers to customers based in part on the distance from the customer to the merchant's location after receiving an indication of a transaction event. After receiving an indication of a point-of-transaction event, indicating a customer may be receptive to additional offers for products or services, a merchant can use positioning data, such as global positioning data, mobile device data, social networking data, Internet search data, and the like to determine the customer's current location. This location can be used to determine the customer's distance from the merchant's location and the distance can be correlated to offers that may entice the customer to travel to the merchant's location (e.g. more valuable offers to customers located at a greater distance from the merchant). Such offers can be tailored to the customer's needs and preferences by considering other information available to the merchant, such as transactional data, biographical data, social network data, publicly available information, etc. The collection of positioning data, determining the distance from the merchant and correlating the customer's distance from the merchant to offers is generally performed in real-time or near real-time in order to provide offers that are likely to entice the customer to come to the merchant based on the customer's current location. For example, if a customer purchases goods at a department store at a mall in a city, a merchant, such as a financial institution or another department store, may receive notice of this transaction event and conclude that the customer is engaged in commercial activity and may be receptive to an offer for additional goods or services. If the merchant is located in the downtown area of the city a few miles away from the mall, the value of the potential offers will likely need to be greater to entice the customer to come to the merchant's location than if the merchant was another store located in the mall. Accordingly, the merchant may determine the distance of the customer from the merchant by collecting information regarding the customer's current location and select one or more offers of a sufficient value to encourage the customer to leave the mall and to travel to the merchant's location. Inasmuch as financial institutions may be uniquely positioned, through relationships with businesses and customers, to access the data necessary to project a customer's route of travel and specifically target offers to the customer, some embodiments disclosed herein leverage data uniquely specific to financial institutions. However, such embodiments are exemplary.

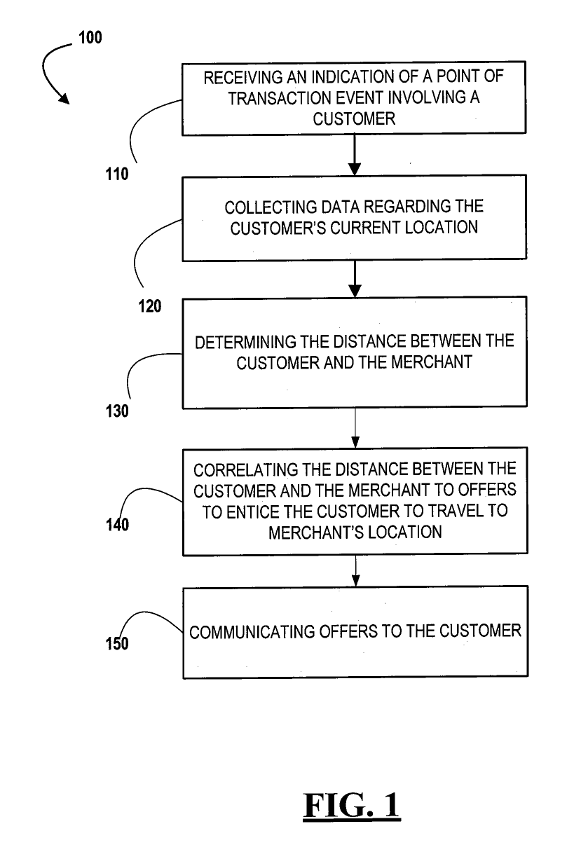

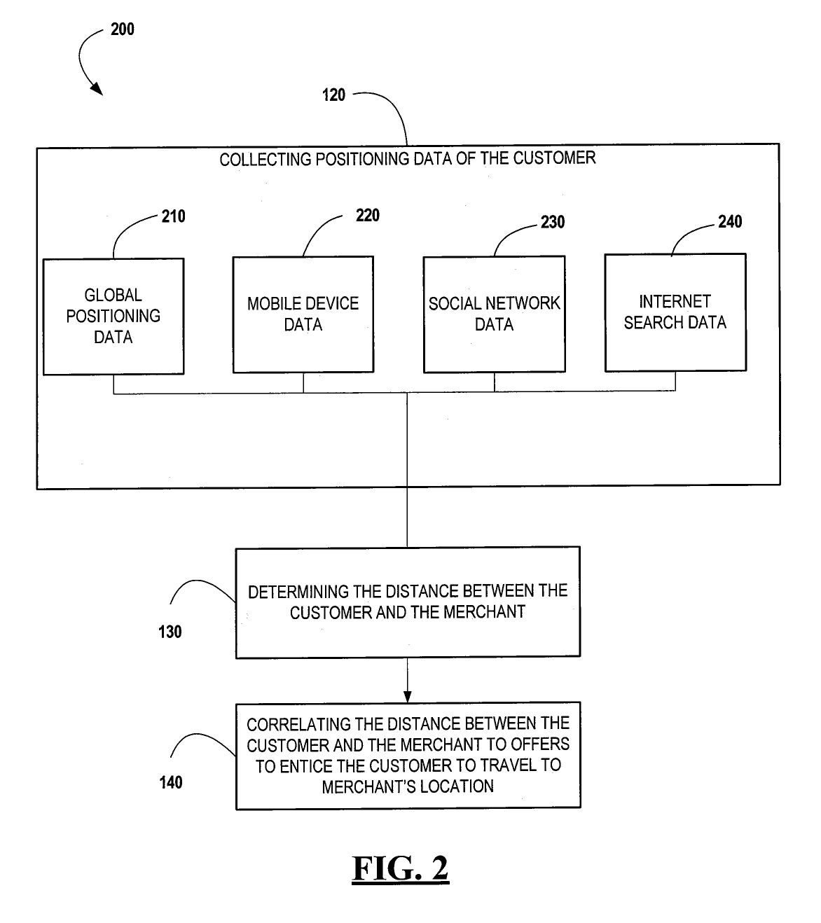

FIG. 1 illustrates a general process flow 100 for communicating offers for goods and services based on the customer's current location, in accordance with an embodiment of the present invention. As represented by block 110, an indication of a point-of-transaction event is received involving a customer. As represented by block 120, a first set of data, comprising positioning data of the customer is collected. At block 130, the positioning data is used to determine the distance between the customer and the merchant. As illustrated by block 140, the distance between the customer and merchant is correlated to offers for products or services that will entice the customer to travel to the merchant's location and at block 150 one or more of the offers is communicated to the customer. Embodiments of the process 100, and systems for performing the process 100, are described in greater detail below with reference to FIGS. 2-5.

FIG. 2 illustrates a general process flow 200 for collecting the first set of data, wherein the first set of data comprises positioning data of the customer, consistent with embodiments of the present invention. The positioning data is used to determine the customer's current location. As represented by block 210, the positioning data may include global positioning data. Global positioning data may include any information collected from methods, systems, apparatus, computer programs etc. involving locating a user's position relative to satellites, fixed locations, beacons, transmitters or the like. In some instances, global positioning data may be collected from a GPS device, such as a navigation system. Such a navigation system may be, but is not limited to, hardware and/or software that is part of a mobile phone, smartphone, PDA, automobile, watch etc. or a commercially available personal navigation system such as a Garmin®, TomTom® or the like. The amount, nature and type of the global positioning data that is collected may depend on the merchant's relationship with the customer and the amount of information that the customer has authorized the merchant or third-party provider to collect. For instances, in some embodiments the global positioning data will be snapshots of the user's location at different times. For example, a snapshot of the user's location will be collected each time the GPS software, navigation system or application is activated. In such embodiments, the global positioning data may only provide historical information regarding the customer's location (e.g. at 9:30 a.m. the customer activated the GPS software and was at location X). Such historical positioning data may be used to estimate the customer's current position, such as determining a range of distances the customer may have traveled in the intervening time. Alternatively, the global positioning data may be combined with other positioning data to locate the customer's current position. In other instances, the global positioning data may dynamically provide information regarding the customer's current location as the customer moves from location to location. In such instances, additional positioning data may not be necessary to identify the current location of the customer or can be used to confirm the customer's location.

As shown in block 220 of FIG. 2, positioning data of the customer may include mobile device data. Mobile device data may include information regarding the current location of the customer's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the current location of a mobile phone may be dynamically determined from the cell phone signal and cell towers being accessed by the mobile phone. In other instances, a mobile device may include software or hardware to locate the position of the mobile device from GPS signals, wireless network locations, and the like. Mobile device data may further include information from an accelerometer that is a part of the mobile device and provides information regarding whether the mobile device is moving, and if so, in what direction. Furthermore, mobile device data may be the time and location of calls placed using the telephone functionality of a mobile device. By way of example, if a customer purchases a cup of coffee at a local coffee house, and thereby triggers an indication of a point-of-transaction event, a merchant may be able to locate the customer if the customer logs onto a wireless network at the coffee house (for instance by locating the IP address associated with the wireless network). In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position.

Referring now to block 230, the positioning data of the customer may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks such as Facebook®, Twitter®, FourSquare®, Linkedin®, YouTube® as well as any one or more existing web logs or “blogs,” forums and other social spaces. Social network data may indicate the customer's recent, present or future location through expressed data. For instance, a user may upload a blog post, comment on a connection's page, send a friend an electronic message etc. that identifies the customer's location (e.g. micro-blog entry “Just enjoyed lunch at a new restaurant on 5^{th} street . . . check it out.”). Moreover, many already-existing social networks provide users with the ability to “check-in”, “flag” or otherwise indicate the user's current location. Accordingly, customer positioning data collected from social networking data may consist of such indications. Furthermore, many social networks allow users to rate, like, comment etc. on restaurants, attractions, locations and the like. Accordingly, a customer may indicate that he ate at a certain restaurant or business at a given time and thereby provide information about his location at that time. Furthermore, a customer may upload photographs to a social networking site and thereby provide information about the customer's location. In some instances the customer's location may be determined from the picture, (for example a picture of a state line sign, a highway sign, a mile marker etc.) or a caption associated with the picture may indicate the customer's location and/or the time the photo was taken. As with the global positioning data, if the social network data only includes historical location data, the social network data may be used to estimate the customer's location or be combined with other positioning data to locate the customer.

As shown in block 240, the positioning data of the customer may also be collected from Internet data. Internet data, may include any information relating to the searches conducted by the customer, website's visited by the customer and the like that suggests the customer's present or future location(s). For instance, a customer may review an online menu for a restaurant prior to visiting the restaurant. Similarly, a customer may search for current sales being offered prior to visiting a store. A customer may also search for construction or traffic reports indicating planned travel along certain roads. It will be understood that such Internet data may relate to searches or websites visited by the customer before the indication of the transaction event (e.g. while the customer is still at home or work), however, inasmuch as many mobile devices also include mobile Internet connectivity, it will also be understood that such information may be dynamically collected as the customer moves from location to location.

As shown by block 130, once the positioning data of the customer is collected from one or more of the global positioning data 210, mobile device data 220, social network data 230 and Internet data 240, the positioning data is used to determine the distance between the customer and the merchant. It will be understood that the positioning data may be data that is available directly to the merchant or data that is collected by other merchants or a third-party service provider and then provided to the merchant. In some instances, determining the distance between the customer and the merchant is based solely on the positioning data currently being collected, e.g. the user's current GPS location is sufficient to identify the customer's present location with sufficient certainty to determine the customer's distance from the merchant. In other instances, the current positioning will be combined with historical positioning data to project the customer's current location. For instance, if the available positioning data is only able to identify where the customer was an hour ago, historical positioning data might be used to determine the customer's likely location. For instance, if at 9:35 a.m. the mobile device data indicates the customer was located at a mall but it is now 11:45 a.m. and no other positioning data is available, historical positioning data may, for example, indicate that the customer habitually goes to a specific restaurant each time he goes to the mall allowing the merchant to conclude that the customer is likely at the restaurant. Similarly, the positioning data being currently collected about the customer may be combined with information regarding the positioning data of other users in similar situations to project the customer's likely current location. Consider for example the customer described above who was located at a mall at 9:35 a.m. A review of other data available to the merchant may indicate that the majority of customers that visit a mall at specific times of day will more often than not eat at a restaurant within two miles of the mall's location. This information can be combined with the current positioning data of the customer to determine the customer's distance from the merchant.

At block 140, the distance between the customer and the merchant is correlated to offers that the merchant may communicate to the customer to entice the customer to travel to the merchant's location. Consider a simplified example of process flow 200 in use, a merchant is willing and able to provide customers a coupon to purchase goods from the merchant at a 5%, 10% and 20% discount. The merchant may determine that the most efficient use of its available offers is to provide the 5% coupons to customers within three miles of the merchant, the 10% coupons to customers between three and five miles from the merchant and the 20% coupons to any customers located over five miles away from the merchant. The merchant receives an indication of a point of transaction event providing evidence that the customer is engaged in commercial activity. The merchant collects positioning data from the customer, for instance collecting the customer's location from a GPS device on the customer's smartphone and determines that the customer is five miles from the store. This distance correlates to an offer for 10% coupon. It will be understood that this example is a simplified example of the possible applications of the present invention. It will also be understood that the offers contemplated herein are not limited to coupons or similar discounts but rather may be any inducement to attract the customer to travel to the merchant's location. It will also be understood that the value or nature of offers to be communicated to the customer may be dynamically determined, rather than based on a predetermined model as discussed above. For instance, the nature or value of the offers may be based on the number of indications of transaction events received and the relative distance of all of the customers from the merchant in order to most efficiently attract customers to travel to the merchant's location.

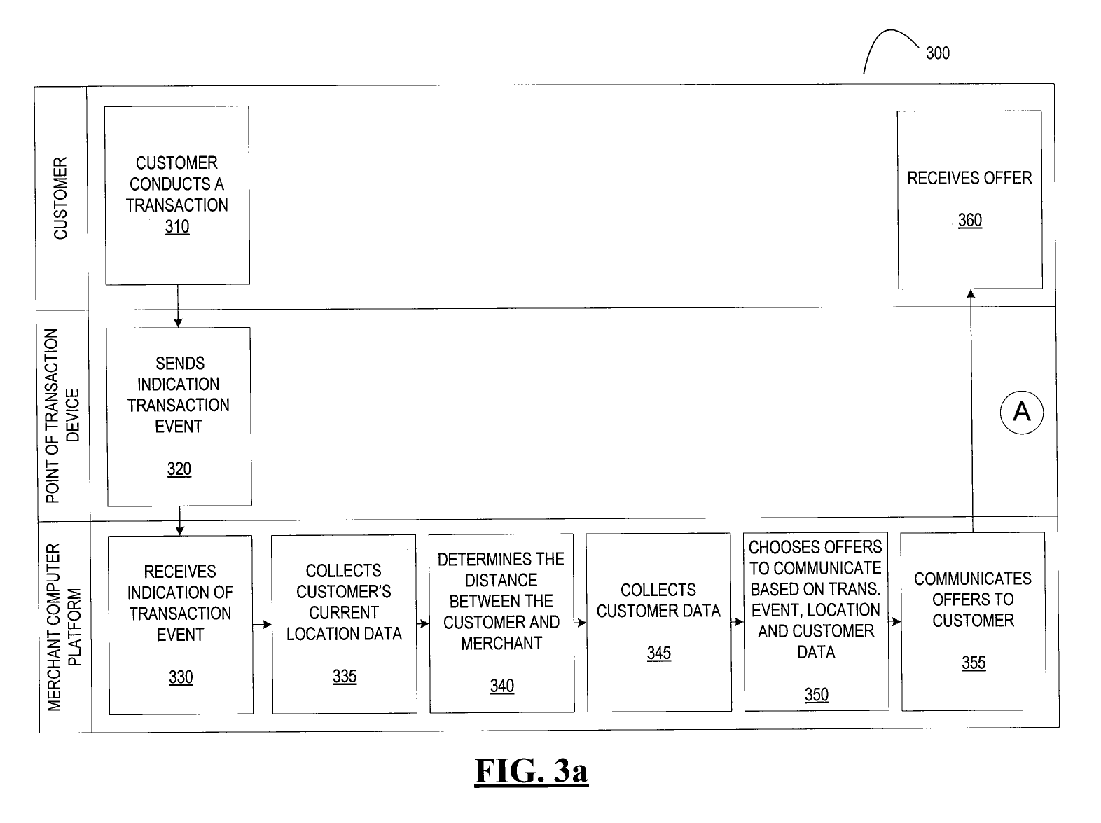

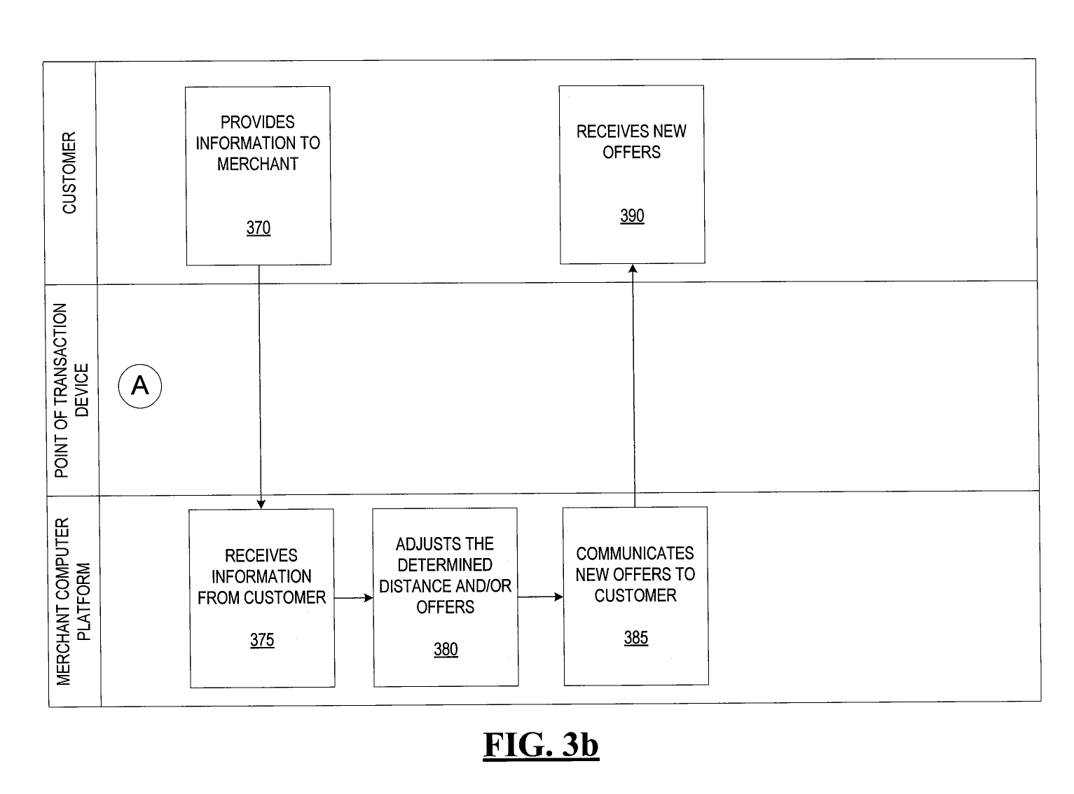

Referring now to FIGS. 3a and 3b, which provide a mixed block and flow diagram illustrating a process flow 300 for communicating offers for goods and services based on the customer's current location, in accordance with an embodiment of the present invention. As shown, in some embodiments, steps of the computer-implemented method 300 are performed by the customer, a point-of-transaction device and/or merchant computer platform. The computer-implemented method 300 allows a merchant to communicate offers for goods or services to a customer that has opted to receive such offers after the customer engages in a transaction. The merchant collects positioning data to identify the customers current location, determines the distance between the customer and the merchant, collects customer data about the customer's purchasing habits/preferences and identifies, then communicates, offers in which the customer may be interested, based in part on the indication of the point-of-transaction event, the customer's current location and the customer data. Moreover, in some embodiments, as illustrated by FIG. 3b, the customer may provide feedback to the merchant regarding either the customer's current location or the communicated offer and the merchant can identify alternate offers and communicate alternative offers to the customer.

In block 310, a customer conducts a transaction. The transaction may involve the same merchant that later offers additional goods and services to the customer or the merchant may be unrelated to the later merchant. In some embodiments, as the customer is conducting a transaction she will be prompted to indicate whether she is willing to receive targeted offers from the merchant or merchants. In other embodiments, the customer has preemptively elected to receive such offers. As shown in block 320, the point-of-transaction device sends an indication of the transaction event to the merchant computer platform. In some embodiments, the point-of-transaction device will be the same device that facilitated the transaction. In other embodiments, the point-of-transaction device will be one or more servers specifically configured to receive notice of a transaction event and communicate the same to the merchant computer platform. Accordingly, the point-of-transaction device may be maintained by the entity involved in the original transaction, the merchant or a third-party service provider. In certain embodiments, the indication of a point of transaction event will include specific information. Such information may include, but is not limited to, the time the transaction occurred, the location where the transaction occurred and item level information regarding the goods or services purchased. As illustrated by block 330, the merchant computer platform receives an indication of the transaction event, which triggers the remaining actions in the process flow 300. In embodiments where the indication of the transaction event is received at, or near, the time the transaction event occurs, the specific information included with the transaction event (e.g. time and location) may be all that is needed to determine the customer's current location. In embodiments where the indication of a transaction event does not include location information or receipt of the indication of a transaction event does not occur at the same time as the transaction, as shown at block 335, the merchant computer platform collects customer positioning data to identify the customer's current location. As shown in block 340, once the customer's current location is identified the distance between the customer's present location and the merchant's location is determined, consistent with the embodiments discussed herein in connection with FIG. 2.

In the embodiment shown in FIG. 3a the apparatus also collects a second set of data, in addition to the customer positioning data, comprising information about the customer, as illustrated by block 345. It will be understood that the term “customer data,” as used herein, generally refers to any information that relates to a customer and/or the customer's purchasing behavior. Such customer data may include any information that can be used to determine what goods or services the customer may be interested in receiving future offers. As shown in block 350, offers are chosen to communicate to the customer. The determination of what offers to communicate to the customer is based in part on the indication of a point-of-transaction event, the customer's current location, as well as the collected customer data. For instance, consider a financial institution that has business relationships and partnerships with a number of other merchants, including a merchant that operates an outlet mall. The financial institution may receive an indication of a transaction event consisting of a mobile balance inquiring from an existing customer. If customer positioning data indicates the customer is currently located twenty miles away from the outlet mall, the financial institution may conclude that it may need to provide a significant offer to entice the customer to travel to the outlet mall. However, this conclusion does not provide any information regarding what type of offers may be most relevant to the customer. The financial institution, because of its relationship with the customer, may have access to data that indicates that when the customer comes to the outlet mall he stops at the same stores each time. Accordingly, an offer relating to goods or services from these particular stores may be more likely to entice the customer to travel to the outlet mall. Similarly, if the financial institution has access to customer service information (e.g. a call center transcript) indicating the customer had a bad experience with one of the retailers in the outlet mall, the financial institution may elect to avoid sending offers related to that retailer. Moreover, if the indication of the point of transaction event includes information about the transaction, this information can also be used to target the offers to the customer. For instance, if the transaction event occurred at 8:50 p.m., and the outlet mall's stores close at the 9:00 p.m. the offers may relate to purchases for the following day. Similarly, if the transaction event indicates that customer purchased a new pair of shoes, the offers to be communicated to the customer may avoid offers for shoes, or if the available customer data suggests it would be appropriate, an offer for shoes of a different style. As another example, the transaction event may indicate what day of the week the transaction occurred. Available customer data may indicate that customers are more likely to purchase meals at a sit-down restaurant on Saturdays and Sundays and fast food meals Monday to Friday. Accordingly, if the indication of a transaction event indicates the transaction occurred on a Tuesday, the offers to be communicated to the customer might exclude offers for sit-down restaurants or may increase the value of the standard offer for a sit-down restaurant in an effort to overcome the customer's normal pattern of behavior.

As illustrated by block 355, after one or more offers have been chosen, the offers are communicated to the customer. This communication may be achieved by any means sufficient to relay the offer from the merchant to the customer. In some embodiments, the communication will be made electronically to a mobile device in the customer's possession. The communication may be an e-mail, sms message, phone call etc. Moreover, the communication may be a routine or function of an application or computer program on the mobile device and may include an indicator appearing on the display of the mobile device. The communication may also appear as a banner advertisement, pop-up or targeted advertisement within an Internet website accessed by a web browser application on the mobile device. In some embodiments, the communication will include the location and or navigation data necessary for the customer to come to the merchant's location to use the offer. In some instances, the communication will push the location and/or navigation data directly to the customer's mobile device or navigation system and present the customer with the option to navigate to the merchant's location.

As illustrated by block 360, the customer receives the offer or offers. The receipt of an offer may include the ability for the customer to share the offer with another customer. For instance, the offer may enable the customer to email the offer to another individual or for the customer to provide a name and contact information of another customer who may be interested in a similar offer. Similarly, the customer may be able to post the offer, or otherwise transmit the offer to friends and family who are connected to the customer through a social network. This sharing of the offer may be done manually by the customer or may occur automatically based on the customer's preferences.

Referring now to FIG. 3b, in certain embodiments, after the customer receives an offer from the merchant, as illustrated by block 370 the customer may provide information to the merchant responsive to the offer(s). The information may relate to the customer's current location or it may relate to the nature of the offers. For instance, the customer may indicate that the conclusion regarding the customer's current location is incorrect (e.g. the positioning data was based on the location of a mobile device which was not with the customer) and indicate the correct location. Similarly, the customer may indicate that she is not interested in offers of the nature communicated by the merchant. The customer may also provide information regarding the nature of offers the customer has received from other merchants and/or identify specific offers the customer would be interested in receiving. In some embodiments the ability to provide information to the merchant is embedded directly in the communication received from the merchant, such as a web link or the like. Alternatively, the ability to provide information may be a function of an application of a computer program on the customer's mobile device. As represented by block 375 the merchant computer platform receives the information from the customer and at block 380, adjusts the determined distance between the customer's location and the merchant's location and/or the nature of the identified offers based on the information provided by the customer. As block 385, the merchant communicates new offers to the customer and the customer receives the new offers as shown in block 390.

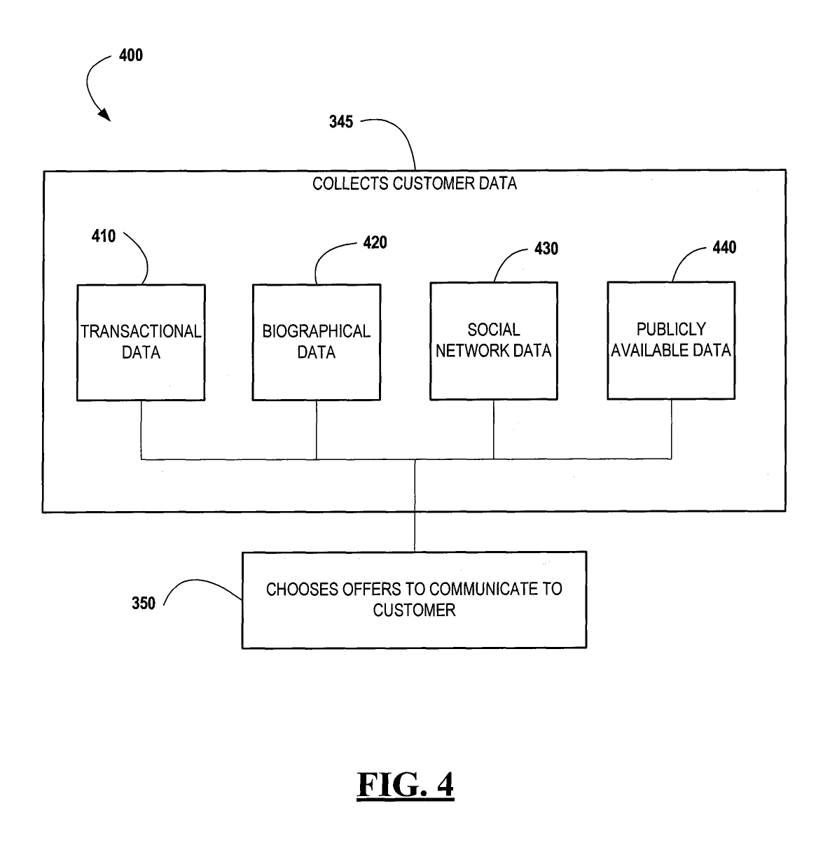

FIG. 4 illustrates a flow diagram illustrating a process flow 400 for collecting customer data, in accordance with an embodiment of the present invention. As illustrated by block 410, customer data may include transactional data. Transactional data includes, but is not limited to, data regarding the date, location, amount, method of payment etc. of the transactions of the customer. The transactional data may be historical transaction data or may be data relating to the transaction that is the subject of the point of transaction event. It will be understood that such data may illustrate patterns of purchases that may be predictive of a customer's purchasing behaviors. For instance, transactional data may indicate that a customer regularly buys coffee from coffee shops. Accordingly, the customer may be receptive to offers for discounts to coffee. Moreover, the transactional data may indicate that the customer does not generally eat out in restaurants, and consequently, may be more receptive to offers for discounts to a local supermarket then offers relating to a local restaurant. Moreover, transactional data may indicate patterns of behavior relating to where a customer shops. For instance, available transactional data may indicate that a customer routinely stops at the same gas station once every two weeks. Such information may be useful to a merchant targeting offers to this customer. For example, if a competing gas station is interested in capturing the customer's business the size of the offers or discounts it may be required to offer the customer to have her change her purchasing routine may be more substantial than if the offer was based solely on the distance the customer has to travel to reach the competing gas stations' location.

As illustrated by block 420, customer data may be collected from biographical data. Biographical data includes, but is not limited to, the age, sex, marital status, place of residence, current location, number of children, employment status etc. of a customer. Such data may be available to a merchant based on the merchant's prior dealings with the customer, through account applications, loyalty programs, and the like. For instance, a financial institution may have access to biographical data from a customer's earlier mortgage application. Similarly, a retailer may have access to biographical data from the customer's enrollment in the retailer's rewards program. In use, such information may be helpful in targeting offers to a customer by limiting offers to those that are generally appropriate for one with similar biographical data. For instance, if a merchant knows through a retail credit card application that the customer is 19 years old and a college student, an offer for a luxury hotel and spa may not be appropriate unless other data indicates the customer has significant income. However, an offer for a budget motel, a local night club or pizza restaurant may be appropriate. Similarly, if a merchant has access to data indicating the customer has two small children, offers for family friendly events may be more likely to be accepted by the customer than offers for events intended for couples only.

As illustrated by block 430, customer data may also include social network data. Social network data includes, but is not limited to, postings, comments, profile information, blog entries, micro-blog entries, updates, communications, photos, chat transcripts etc. Such information may directly provide information regarding the customer's purchasing preferences. For instances, a customer may “like” a certain merchant's Facebook® page or follow a certain merchant's Twitter® feed. Moreover, as discussed above, if a customer uses features of social networking sites, such as checking-in, that identify where the user has been, this information may provide further information regarding the businesses that the customer frequents. Photos uploaded to social networking sites may similarly illustrate preferences. By way of example, software that includes object recognition may be able to determine the brand names of clothing that the customer is wearing and conclude that the customer likes these brands. Also, photographs of locations may provide information regarding where the customer goes etc.

As shown in block 440, customer data may also be collected from publicly available data. While potentially related to social networking data to the extent the publicly available data is found online, this information may also include information that others have written about the customer, such as news articles, birth announcements, marriage announcements, job promotions, recordation of deeds or other legal documents, marriage or birth certificates etc. Moreover, such information may include reviews that the customer has left regarding goods and services. For instance, if a customer reviews a product or service online, this review may be publicly available and may provide insight into the customer's purchasing preferences.

As illustrated by block 350, the transactional data 410, biographical data 420, social network data 430 and publicly available data 440 is collected and considered in combination with the indication of a point-of-transaction event, and positioning data to choose offers to be communicated to the customer. By way of example, consider a customer that purchases clothes from an athletics store. The point of transaction event triggers the collection of the customer's positioning data. The customer's GPS data and phone data indicate that the customer is located three miles from a local gym that is seeking to add new members and based on the item level information of the indication of a transaction event, the gym may conclude that the customer is interested in athletic activity. A review of the customer's biographical data 420 indicates that the customer is married but has no children. Moreover, the transactional data indicates that the customer already has recurring monthly payments to a competing gym. Based on this information, the gym may conclude that the customer may be interested in offers for a gym membership and that there may be an opportunity to also offer a gym membership for the customer's husband. However, inasmuch as the customer is already a member at another gym, the merchant may need to increase its incentive offer higher than it would have based solely on the customer's location respective to the gym's location.

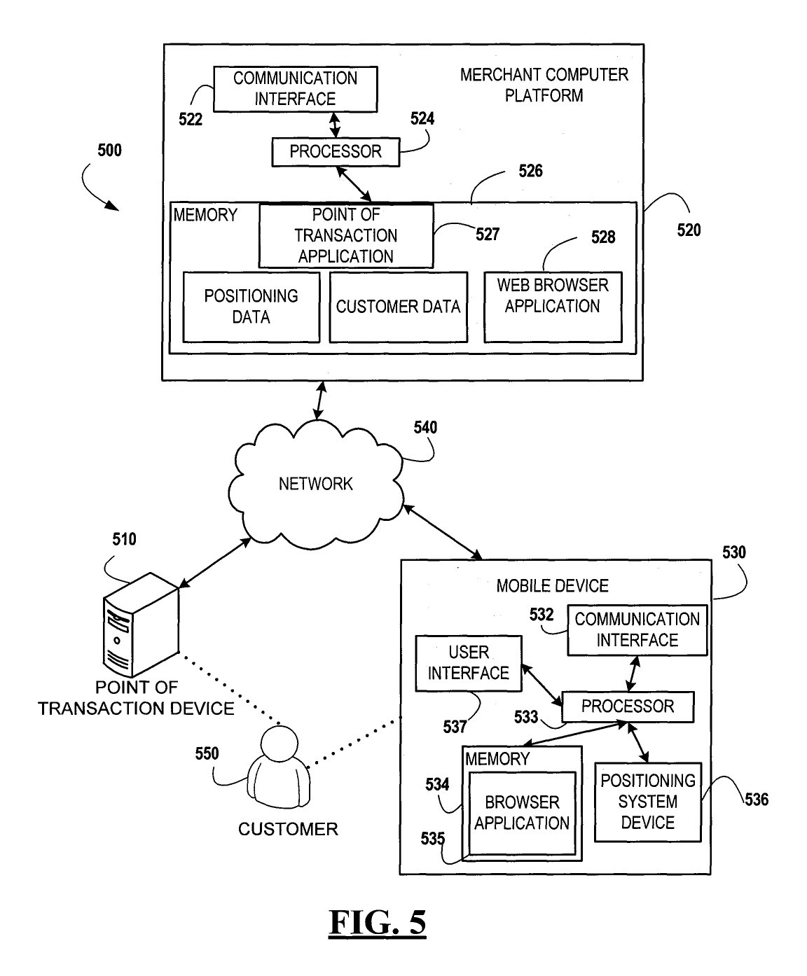

FIG. 5 provides a block diagram illustrating technical components for a system 500 for communicating offers for goods and services based on the customer's current location, in accordance with an embodiment of the present invention. As illustrated, the system 500 includes a point-of-transaction device 510, a merchant computer platform 520, a mobile device 530, a network 540 and a customer 550. It will be understood that the customer 550 has access to the mobile device 530.

In some embodiments, the point-of-transaction device 510 may be operatively and selectively linked to the merchant computer platform 520 over the network 510. As illustrated, some embodiments of the merchant computer platform 520 may include a point-of-transaction application 527 configured to receive indications of point-of-transaction events from the point-of-transaction device 510.

As shown in FIG. 5, the point-of-transaction device 510, merchant computer platform 520 and mobile device 530 are each operatively and selectively connected to the network 540, which may include one or more separate networks. In addition, the network 540 may include a local area network (LAN), a wide area network (WAN), and/or a global area network (GAN), such as the Internet. It will also be understood that the network 540 may be secure and/or unsecure and may also include wireless and/or wireline technology.

The mobile device 530 may include any computerized apparatus that can be configured to perform any one or more of the functions of the mobile device 530 described and/or contemplated herein. As shown in FIG. 5, in accordance with some embodiments of the present invention, the mobile device 530 includes a communication interface 532, a processor 533, a memory 534 having a browser application 535 stored therein, a positioning system device 536, such as a GPS device, and a user interface 537. In such embodiments, the communication interface 532 is operatively and selectively connected to the processor 534, which is operatively and selectively connected to the user interface 537, the memory 534 and the positioning system device 536.

The user interface 538, which may allow the mobile device 530 to receive data from the customer 550, may include any of a number of devices allowing the mobile device 530 to receive data from the customer 550, such as a keypad, keyboard, touch-screen, touchpad, microphone, mouse, joystick, stylus, other pointer device, button, soft key, and/or other input device(s). In some embodiments, the user interface 538 also includes one or more user output devices, such as a display and/or speaker, for presenting information to the customer 550.

Each communication interface described herein, including the communication interface 532 and 522, generally includes hardware, and, in some instances, software, that enables a portion of the system 500, such as the processor 533 to transport, send, receive, and/or otherwise communicate information. For example, the communication interface 532 of the mobile device 530 may include a modem, server, electrical connection, and/or other electronic device that operatively connects the mobile device 530 to another electronic device, such as the electronic devices that make up the merchant computer platform 520.

Each processor described herein, including the processor 533 and 524, generally includes circuitry for implementing the audio, visual, and/or logic functions of that portion of the system 500. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as the memory 534 of the mobile device 530 and the memory 526 of the merchant computer platform 526.

Each memory device described herein, including the memory 536 for storing the browser application 535 and other data and/or programs, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 534 includes a browser application 535. The browser application 535 may be used by the customer 550 to conduct Internet searches and/or access online social networks over the network 540. In some embodiments, the browser application 535 includes computer-executable program code portions for instructing the processor 534 to perform one or more of the functions of the browser application 535 described and/or contemplated herein. In some embodiments, the browser application may be configured to a collect and transmit through the communication interface data collected from the Internet searches conducted by the customer 550 and/or the social network data accessed using the mobile device 530. In some embodiments, the browser application 535 may include and/or use one or more network and/or system communication protocols.

It will be understood that the mobile device 530 can be configured to implement one or more portions of the process flows described and/or contemplated herein. For example, in some embodiments, the user interface apparatus 530 is configured so that the communication interface 532 is operatively and selectively linked to the merchant computer platform 520 to provide positioning data of the customer 550. For instance, the positioning system device 536 and/or the browser application 535 may provide global positioning data 210, social networking data 230 and Internet search data 230 to the merchant computer platform to be processed 520 to determine the customer's current location. The processor 533 or some other apparatus of the mobile device 530 may be configured to collect and transmit the mobile device data 220 to the merchant computer platform 520. Similarly, the mobile device 530 may be used to collect and provide some, or all, of the customer data discussed in process flow 400 of FIG. 4.

FIG. 5 also illustrates a merchant computer platform 520, in accordance with an embodiment of the present invention. The merchant computer platform 520 may include any computerized apparatus that can be configured to perform any one or more of the functions of the merchant computer platform 520 described and/or contemplated herein. In accordance with some embodiments, for example, the merchant computer platform 520 may include an engine, a platform, a server, a database system, a front end system, a back end system, a personal computer system, and/or the like. In some embodiments, such as the one illustrated in FIG. 5, the merchant computer platform 520 includes a communication interface 522, a processor 524 and a memory 526. In some embodiments, as illustrated in FIG. 5, a point-of-transaction application 527 and web browser application 528 may be stored in memory 526. Moreover, in certain embodiments the positioning data and customer data collected in accordance with the process flows described and/or contemplated herein may be stored in memory 526 for access by the processor 524. The communication interface 522 is operatively and selectively connected to the processor 524, which is operatively and selectively connected to the memory 526.

In some embodiments, the processor 524 (and/or the processor 533) may also be capable of operating one or more applications, such as one or more applications functioning as an artificial intelligence (“AI”) engine. The processor 524 may recognize, by way of the AI engine, locations, product or service offers etc. that it has previously communicated to the customer as well as the customer's response to the communicated offers (e.g. whether the offer was accepted, rejected or the customer provide additional information etc.). In this way, the processor may recognize locations, offers and the like and store information related to the locations, offers etc. in one or more memories discussed herein, such as memory 526. Once the AI engine has thereby “learned” of common locations, offers and the customer's response to such offers, the AI engine may run concurrently with and/or collaborate with other modules or applications described herein to perform the various steps of the methods discussed. For example, in some embodiments, the AI engine recognizes an offer that appears correlated to the customer's location and customer data but that the customer has routinely rejected in the past. The AI engine may then communicate to another application or module of the merchant computer platform 520, an indication that an alternate offer should be identified. In this regard, the AI engine may provide a baseline or starting point from which to determine offers of goods or services to be communicated to the customer.

As shown in FIG. 5, the memory 526 includes a browser application 528. The browser application 528 may be used by the merchant computer platform 520 to conduct Internet searches for publicly available data and/or access online social networks over the network 540 consistent with the process flows discussed herein in connection with collecting positioning data and/or customer data. In some embodiments, the browser application 528 includes computer-executable program code portions for instructing the processor 524 to perform one or more of the functions of the browser application 528 described and/or contemplated herein. In some embodiments, the browser application 528 may include and/or use one or more network and/or system communication protocols.

It will be understood that the merchant computer platform 520 can be configured to implement one or more portions of the process flows described and/or contemplated herein. For example, in some embodiments, the merchant computer platform 520 is configured so that the communication interface 522 is communicatively linked to the mobile device 530 to collect the positioning data (block 120 of FIGS. 1 and 2) and/or customer data (block 345 of FIGS. 3a and 4). In certain embodiments the web browser application 528, stored in the memory 526 of the merchant computer platform 520 is operatively linked to the network 540 through the communication interface 522 to collect customer data (block 345 of FIG. 4). In some embodiments, point-of-transaction application 527 stored in the memory 526 of the merchant computer platform 520 is configured to receive an indication of a point-of-transaction event from the point-of-transaction device 510 and the processor 524 is configured to use the indication of the transaction event along with the positioning data and customer data to choose offers (block 350 of FIG. 3a). Consistent with certain embodiments, the merchant computer platform 520 is configured to communicate offers to the customer 550. In some embodiments, the communication of offers will be facilitated by the communication interface 522 communicatively linking over the network 540 with the mobile device 530 to transmit the offer. Similarly, in certain embodiments, the communication interface 522 will be configured to receive information from the customer 550 relative to the customer's location or the offer(s) communicated to the customer 550 (block 375 of FIG. 3b).

It will be understood that the embodiment illustrated in FIG. 5 is exemplary and that other embodiments may vary. For example, in some embodiments, some of the portions of the system 500 may be combined into single portion. Specifically, in some embodiments, the merchant computer platform 520 is configured to perform some of the same functions of those separate portions as described and/or contemplated herein. Likewise, in some embodiments, some or all of the portions of the system 500 may be separated into two or more distinct portions.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive of, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for communicating offers for goods and services comprising:
receiving an indication of a transaction event involving a customer;
collecting a first set of data, wherein said first set of data comprises information related to the customer's location;
determining a distance between the customer and a merchant, based in part on the first set of data;
correlating the distance between the customer and a merchant to offers, wherein the offers are intended to entice the customer to travel to the merchant's location; and
communicating the offers to the customer.

2. The method of claim 1, further comprising:
collecting a second set of data, wherein said second set of data comprises information about the customer; and
choosing one or more offers to communicate to the customer based in part on the second set of data.

3. The method of claim 1, wherein the first set of data is collected from at least one of global positioning data, mobile device data, social networking data or search data.

4. The method of claim 2, wherein the second set of data is collected from at least one of transaction data, biographical data, social network data or publicly available data.

5. The method of claim 1, wherein the indication of a transaction event includes information regarding the transaction

6. The method of claim 6, wherein the information regarding the transaction comprises the time the transaction occurred.

7. The method of claim 6, wherein the information regarding the transaction comprises the location where the transaction occurred.

8. The method of claim 6, wherein the information regarding the transaction comprises item level information about what was purchased.

9. The method of claim 1, wherein the first set of customer data includes the indication of a transaction event.

10. The method of claim 2, wherein choosing one or more offers to communicate to the customer is based in part on the indication of a transaction event.

11. The method of claim 1, wherein the offers are selected from discounts for goods or services offered by the merchant, discounts for goods or services offered by other merchants, access to goods or services otherwise unavailable to the customer, reductions in fees

12. The method of claim 1, further comprising the steps of:
receiving information from the customer relative to the customer's location;
adjusting the determined distance between the customer and the merchant, based in part on the information received from the customer;
communicating alternative offers to the customer.

13. The method of claim 1, further comprising the steps of:
receiving information from the customer relative to the communicated offers;
identifying alternate offers to entice the customer to travel to the merchant's location, based in part on the information from the customer;
communicating alternative offers to the customer.

14. An apparatus comprising:
a computing platform comprising a memory and at least one processor operatively connected with the memory, wherein the processor is configured to:
receive an indication of a transaction event involving a customer;
collect a first set of data, wherein said first set of data comprises information related to the customer's location;
determining a distance between the customer and a merchant, based in part on the first set of data;
correlating the distance between the customer and a merchant to offers, wherein the offers are intended to entice the customer to travel to the merchant's location; and
communicate the offers to the customer.

15. The apparatus of claim 14, wherein the processor is further configured to:
collect a second set of data, wherein the second set of data comprises information about the customer; and
choose one or more offers to communicate to the customer based in part on the second set of data.

16. The apparatus of claim 14, wherein the first set of data is collected from at least one of global positioning data, mobile device data, social network data or search data.

17. The apparatus of claim 15, wherein the second set of data is collected from at least one of transaction data, biographical data, social network data or publicly available data.

18. The apparatus of claim 14, wherein the indication of a transaction event includes information regarding the transaction.

19. The apparatus of claim 18, wherein the information regarding the transaction comprises the time the transaction occurred.

20. The apparatus of claim 18, wherein the information regarding the transaction comprises the location where the transaction occurred.

21. The apparatus of claim 18, where the information regarding the transaction comprises item level information about what was purchased.

22. The apparatus of claim 14, wherein the first set of customer data includes the indication of a transaction event.

23. The apparatus of claim 15, wherein the processor is configured to choose one or more offers to communicate to the customer is based in part on the indication of a transaction event.

24. The apparatus of claim 14, wherein the offers are selected from discounts for goods or services offered by the merchant, discounts for goods or services offered by other merchants, access to goods or services otherwise unavailable to the customer, reductions in fees

25. The apparatus of claim 14, wherein the processor is further configured to:
receive information from the customer relative to the customer's location;
adjust the determined distance between the customer and the merchant, based in part on the information received from the customer; and
communicate alternative offers to the customer.

26. The apparatus of claim 14, wherein the processor is further configured to:
receive information from the customer relative to the communicated offers;
identify alternate offers to entice the customer to travel to the merchant's location, based in part on the information received from the customer;
communicate alternative offers to the customer.

27. A computer program product comprising a non-transitory computer-readable medium having computer-executable code stored thereon, the computer-executable code comprising:
a first code portion configured to receive an indication of a transaction event involving a customer;
a second code portion configured to collect a first set of data, wherein said first set of data comprises information related to the customer's location;
a third code portion configured to determine a distance between the customer and a merchant, based in part on the first set of data;
a fourth code portion configured to correlate the distance between the customer and a merchant to offers, wherein the offers are intended to entice the customer to travel to the merchant's location; and
a fifth code portion configured to communicate the offers to the customer.

28. The computer program product of claim 27, further comprising:
a code portion configured to collect a second set of data, wherein said second set of data comprises information about the customer; and
a code portion configured to choose one or more offers to communicate to the customer based in part on the second set of data.

29. The computer program product of claim 27, wherein the first set of data is collected from at least one of global positioning data, mobile device data, social networking data or search data.

30. The computer program product of claim 28, wherein the second set of data is collected from at least one of transaction data, biographical data, social network data or publicly available data.

31. The computer program product of claim 27, wherein the indication of a transaction event includes information regarding the transaction.

32. The computer program product of claim 31, wherein the information regarding the transaction comprises the time the transaction occurred.

33. The computer program product of claim 31, wherein the information regarding the transaction comprises the location where the transaction occurred.

34. The computer program product of claim 31, wherein the information regarding the transaction comprises item level information about what was purchased.

35. The computer program product of claim 27, wherein the first set of customer data includes the indication of a transaction event.

36. The computer program product of claim 28, wherein the code portion configured to choose one or more offers to communicate to the customer choose in part based on the indication of a transaction event.

37. The computer program product of claim 27, wherein the offers are selected from discounts for goods or services offered by the merchant, discounts for goods or services offered by other merchants, access to goods or services otherwise unavailable to the customer, reductions in fees

38. The computer program product of claim 27, further comprising:
a code portion configured to receive information from the customer relative to the customer's location, adjust the determined distance between the customer and the merchant based in part on the information received from the customer and communicate alternative offers to the customer.

39. The computer program product of claim 27, further comprising:
a code portion configured to receive information from the customer relative to the communicated offers, identify alternate offers to entice the customer to travel to the merchant's location, based in part on the information received from the customer, and communicate alternative offers to the customer.
